(19) United States
(12) Patent Application Publication
(10) Pub. No.: US 2004/0073795 A1
(43) Pub. Date: Apr. 15, 2004

(54) Systems and methods for password-based connection

(76) Inventor: David P. Jablon, Westboro, MA (US)

Correspondence Address: Kimberley G. Nobles, IRELL & MANELLA LLP, 840 Newport Center Drive, Suite 400, Newport Beach, CA, 92660, US

(21) Appl. No.: 10/268,160

(22) Filed: Oct. 10, 2002

(51) Int. Cl. H04L 9/00

(52) U.S. Cl. 713/171

(57) ABSTRACT

Cryptographic systems and methods that allow secure connection of two devices over an open network, using passwords communicated in an out-of-band process. One-time versus static passwords, active versus passive models of user participation, and different combinations of password-input and password-output mechanisms may be employed. The present invention uses either a password agreement protocol or a zero-knowledge password proof to securely establish a shared password and a shared key between two parties, and incorporates explicit steps to insure that the user(s) of the system authenticates that the same password, and thus the same key, is used at both devices.

### BACKGROUND

The present invention relates to improved methods that help people securely connect two devices.

The simple act of plugging together components, two at a time, is an essential step in establishing global networks. Plugging together two components may occur at any architectural level (link, transport, application, etc.) although the layering issues are somewhat irrelevant for the purposes of the present invention. It is sufficient to say that some set of cryptographic keys is negotiated to secure network communications between pairs of components, and to make the connection, a user ultimately interacts with these devices.

The present invention focuses on using passwords that are easy for people to remember, easy to type or say, and easy to recognize by sight, sound, or perhaps touch, and the various uses of these small authentication keys. Think about a 10 to 20-bit numeric value, signifying somewhere between a thousand or a million possibilities, expressed in any suitably convenient manner. Classical key-based cryptographic methods (either symmetric or asymmetric) generally require at least 80 bits or more of such data to be safely used as a secret or private key. The focus of the present invention is to optimize the overall user experience, and maximize the value of smaller authenticators. Convenience is paramount in many product development and deployment scenarios, and it is not desirable for users or implementors of systems to be forced into having to trade away security for the sake of convenience.

The modern history of the secure connection problem began with the Diffie-Hellman key exchange protocol discussed in W. Diffie & M. E. Hellman, “Privacy and Authentication: An Introduction to Cryptography”, Proceedings of the I.E.E.E., vol. 67, No. 3, March 1979, which addressed how to establish an unauthenticated cryptographic key between one user and another user. However, the Diffie-Hellman (DH) protocol alone does not address the issue of a malicious middle party, or more generally, the issue of whether the other user 14b is the intended other party. Authenticated key exchange protocols address this problem using additional authentication information established between the two users, using an out-of-band process.

The concept of using commitments to prevent middleman attack, which is discussed further below in the context of the present invention, was used in Rivest and Shamir's Interlock protocol discussed by R. Rivest and A. Shamir, in “How to expose an eavesdropper”, Communications of the ACM, v. 27, no. 4, April 1984, pp. 393-395. The Interlock protocol may be instantiated in a number of ways as described in B. Schneier, Applied Cryptography Second Edition, John Wiley & Sons, 1996, p. 515. In the Interlock Protocol, Alice and Bob exchange public keys, and then each send to each other a commitment to distinct messages, r_{A} and r_{B}, where each is encrypted or sealed under the other's public key. Only after swapping commitments do they reveal the sealed messages to each other. It has been suggested that the commitment may consist of either sending half of the bits of the public key, or the result of a hash of the public key. After receiving each other's commitment, Alice and Bob each then reveal the encrypted messages to each other.

It has been suggested that the Interlock protocol can be used to secure voice messages that inherently contain information that authenticates the sender, perhaps through voice recognition, knowledge of details of the conversation context, etc. The security of the protocol in such situations may require that the messages remain secret, to prevent spoofing, as described in the book by B. Schneier, Applied Cryptography Second Edition, John Wiley & Sons, 1996, p. 515. See also Bellovin & Merritt's “Attack on Interlock Protocol” paper. The applicability of such methods to the problem of sharing secret information across a crowded room will be discussed below.

Authentication information may generally be in the form of either keys or passwords. In the present invention, a hard line is drawn between a key, which is assumed to be of high cryptographic quality, and a password, which is assumed to be of lower-than-cryptographic quality. Secret keys, private keys, and public keys as used herein have the usual meanings, with presumed acceptable strength. Password denotes a small secret value (such as a PIN code) that is presumed to be unsafe for direct use as a cryptographic key, but remains, nevertheless, a valuable (and safe, when properly used) authentication factor.

There is a vast amount of research on key-based authentication protocols, the shared secret key model (e.g., Needham Shroeder) and the public/private key model. There has also been considerable work on password-authenticated key agreement protocols, that provide a password-based analog of the two dominant key-based models, using passwords as authenticators instead of keys.

The present invention focuses on using password-sized authenticators to make it easy for people to observe, remember, compare, and reproduce these values, and in general, to participate in the act of connection establishment.

In a classic password-based login scenario, a user enrolls his/her password at one device, which transfers the password or related data to an authentication server, which acts as the device authorized to perform future password verifications. At login time, the user inputs the password to a device, which in turn performs a password authentication protocol with the authentication server device. The protocol may require that the system transmit secret credentials from the user's device to the server (although this is not by any means necessary with stronger protocols) and it may utilize digital identifiers and established relationships, perhaps codified in public-key digital certificates. The present invention instead focuses on protocols that work when there is little or no such prior arrangement, with an eye towards establishing that first secure connection.

The act of connecting may be a prelude to loading additional credentials (e.g., keys and certificates) into a device across a network. To simplify the user experience in bootstrapping or initializing network components, it is desirable to rely on the speed, reliability, and security of the network for the transmission of such data, rather than encourage manual entry.

There are many examples of systems that use passwords insecurely. One recent example is the Bluetooth pairing protocol discussed in the “Specification of the Bluetooth System-Core,” Version 1.1, Feb. 22, 2002, which is available at http://www.bluetooth.com/dev/specifications.asp, which uses a PIN code in a challenge/response protocol for authentication of an initial key. Although it accommodates PIN codes up to 128 bits in length, the specification encourages the use of short 4 digit codes, which are insecure. Other systems, such as the secure socket layer (SSL), described by A. Frier, P. Karlton, and P. Kocher in “The SSL 3.0 Protocol”, Netscape Communications Corp., Nov. 18, 1996, for example, support strong modes of key-based authentication, but no secure modes for password-based authentication.

There are also methods that can supplement, extend, or replace these key-based protocols to safely provide mutual authentication based on passwords. Examples of strong password methods include the password authenticated key agreement protocols, such as EKE, discussed by S. Bellovin and M. Merritt, “Encrypted Key Exchange: Password-based protocols secure against dictionary attacks”, Proceedings of the IEEE Symposium on Research in Security and Privacy, May 1992, and SPEKE, disclosed by D. Jablon, in “Strong password-only authenticated key exchange”, ACM Computer Communications Review, vol. 26, no.5, October 1996, pp. 5-26. These methods are the subject of the IEEE P1363.2 proposed “Standard Specifications for Public-Key Cryptography: Password-Based Techniques”, IEEE P1363 Working Group, <http://grouper.ieee.org/groups/1363/>. In one sense, password-based protocols are simply stronger versions of key-based protocols, with extra protection to prevent specific kinds of exhaustive attack. In a larger sense, password-based protocols help a person securely connect one device to another over an open network, in a way that maximizes the effectiveness of the password, and minimizes the complexity of and requirements for out-of-band key agreement.

There are a number of issues to be considered in password-based connection protocols.

A first issue relates to static versus ephemeral passwords. When using static passwords, password-only protocols should use a password authenticated key agreement protocol, that incorporates a zero knowledge password proof (ZKPP) to keep the password secure for the next use. If the password is used more than once, the method for proving knowledge of the password from one user to the other should not leak any information that enables either passive attackers or active attackers from being able to obtain information to crack the password offline. The ideal is to limit active attackers to being able to make only a single guess in each run with a legitimate participant.

However, it has been noted by B. Kaliski that the constraints on the connection problem can be relaxed when using ephemeral (one-time) passwords. The partial or full revelation of a one-time password may not be much of a threat, when the event is properly detected and accounted for in the system. Specifically, ephemeral passwords may be safely used and revealed in the process of authenticating, as long as the overall system prevents malicious re-use of these authenticators. One such system, recently described in a slide presentation by Jan-Ove Larsson, “Higher layer key exchange techniques for Bluetooth security”, Open Group Active Loss Prevention Conference, Amsterdam, Oct. 24, 2001, available at <http:/Hwww.opengroup.org/public/member/q401/outline_agenda.htm>, uses a pre-arranged password to mutually authenticate a key previously established using Diffie-Hellman (DH) other similar unauthenticated (anonymous) key agreement protocols. Mutual authentication is provided using a series of (multi-)bit commitments, where both parties gradually reveal pieces of the password to each other. The process uses multiple passes of commit/reveal messages in an interleaved process. Such bit commitment schemes used for proof of knowledge are of course well known. The leakage of one or more bits of the password in this case is mitigated by the overall system, when the password is ephemeral and chosen randomly by the device. The password size is effectively reduced, by a number of bits that depends on the size of each piece, which is directly related to the size of the password, and inversely related to the number of passes used. This performance/security tradeoff is discussed in the Jan-Ove Larsson, “Higher layer key exchange techniques for Bluetooth security” presentation.

A second issue relates to device-selected versus user-selected passwords. Ephemeral passwords may be selected by either devices or by users. However, in the specific case of user selection, there is a significant chance of password re-use, either from earlier device connections, or perhaps from other important user contexts. For this reason, it is highly recommended that zero-knowledge password proofs be used for all systems that use user-selected passwords, regardless of whether the password is intended to be ephemeral or static.

In this regard, zero-knowledge protocols do not appear to require more computation than the non-zero-knowledge alternatives. Both classes of protocols seem to require at least one exponential exchange, and not much else. However, non-zero-knowledge protocols may require additional message flows.

A third issue relates to unilateral versus mutual authentication. Whether unilateral or mutual authentication is needed depends on the application. In general, the present invention focuses on protocols that provide mutual authentication using a single password.

A fourth issue relates to active versus passive participation. The classic model for user authentication is an In-In active participation model, which requires a user to supply to one device a secret credential, typically a password response to a prompt. Another variation is a system that permits the user to select from a menu of recognizable images, as in the Passface personal authentication system, described in documents available at http://www.realuser.com, and http://www.idarts.com. If the correct data is not entered or selected, the connection fails. This model generally uses static passwords, although ephemeral passwords in the form of one-time token authentication codes also conforms to this model, where a secret value corresponding to the one stored in the token is also made available to an authentication server device. We will also discuss below the Out-In model, where a password is conveyed by the user(s) from one device to another, and the Out-Out model, where two devices display passwords that the user(s) must compare.

When using static passwords, password-only protocols should use a password authenticated key agreement scheme, that incorporates a zero knowledge password proof (ZKPP) to keep the password secure for the next use. If the password is used more than once, the method for proving knowledge of the password from one party to the other should not leak any information that enables either passive attackers or active attackers from being able to obtain information to crack the password offline. The ideal is to limit active attackers to being able to make only a single guess in each run with a legitimate participant.

In some applications it is not possible for a password to be entered on either device. L. Ramasamy suggested the application of purchasing a ticket at a movie hall with a handheld device, where the movie hall displays a “response string” password that the user cross-checks with the handheld display. A Diffie-Hellman-based protocol for this purpose was described by L. Ramasamy in “Bluetooth security”, a message posted to IETF CAT working group mailing list, available at http://groups.yahoo.com/group/cat-ietf/message/1477. This protocol is discussed below, including discussion of a “constructive middleman” attack against it. Similar DH protocols were also described in a patent issued to D. Maher, entitled “Secure communication method and apparatus”, U.S. Pat. No. 5,450,493, issued Sep. 12, 1995, which are also subject to similar attacks.

A PGPfone owner's manual (P. Zimmermann, PGPfone Owners Manual, Version 1.0 beta 6, Mar. 19, 1996) describes an authentication protocol that involves two parties who exchange hashes of Diffie-Hellman public keys, and then exchange the actual public keys. These parties then each compute a small hash of the agreed Diffie-Hellman key to generate entries from a common word list for subsequent voice verification. People compare the spoken words, using their voices and conversational context as evidence of authenticity. In the PGPfone source implementation of this protocol (see P. Zimmermann, PGPfone 2.1 source code, Nov. 1, 1999, available at <http://www.radiusnet.net/crypto/archive/pgp/pgpfone/PGPfone21-win.zip>), the software insures that the hashes of the Diffie-Hellman public keys correspond with the actual keys, and further insures that these keys are within an acceptable range of values. In this software, the pre-exchanged hashes prevent the constructive middleman attack, and the range checking effectively prevents small subgroup attack.

Active model protocols implemented in the present invention will now be discussed. Using the In-In or Out-In models, the user actively conveys the password to at least one device. In these cases, an obvious choice is to use a password-authenticated key agreement protocol that provides a zero-knowledge password proof, such as EKE or SPEKE. Such protocols can mutually prove knowledge of the password from each device to the other, in a way that prevents revelation of the password (other than allowing one guess in each run of the protocol). This is an important requirement when using static or user-chosen passwords.

When using ephemeral passwords, the requirements for the proof scheme can be somewhat relaxed. A zero-knowledge scheme may not be necessary, since it may be acceptable to reveal some part or all of an ephemeral password in the protocol, as long as the participants prevent malicious reuse of the password. Work on a two-password protocol may exist,, in which Alice and Bob use independent random ephemeral passwords, and a scheme with partial leakage was described in the Jan-Ove Larsson, “Higher layer key exchange techniques for Bluetooth security” presentation.

The Out-In model has generally the same requirements as the In-In model. One might safely use a password authenticated key agreement protocol, after the user conveys a static or ephemeral password from one device to the other device in an out of band process. In the case of ephemeral passwords chosen by the “Out” device, the requirements for the password-proof scheme can (in theory) be somewhat relaxed. It may be fine if the password is revealed in the process, as long as the participants can detect this fact and prevent malicious reuse.

Passive model protocols, which may be used in the present invention, will now be discussed. The Out-Out model is a passive participation model where the user does not provide password input to either device. Password-authenticated key agreement protocols do not work in this case, since it is presumed that there is no out-of-band means for a person to communicate a password from one entity to the other.

Instead, each of the devices displays an ephemeral password, that represents a connection identifier, and the user approves of the connection when the two displayed values match. When they match, the connection is guaranteed to be secure against eavesdroppers and middlemen, at least in proportion to the size of the password. When they do not match, the user should generally act to abort the connection, from one side, the other, or both. Aborting the connection can be accomplished in a number of ways, as in for example not clicking “OK” at a prompt that asks if the connection should be allowed, or simply powering down the device, etc. The general outline of a password agreement system was discussed in the Ramasamy “Bluetooth security” message, without details of how the agreed password would be constructed. Essentially the same system was also discussed in the Maher paper, with some further enhancements described below. A protocol that provides this function is called a password agreement protocol, and it must have a crucial property to defend against attack on a low-entropy agreed password.

Note that any passive model scheme works only if the user does not skip the confirmation step, perhaps by blindly clicking “OK” each time. This is a weakness of all passive model authentication schemes, which can fail due to user inaction or inattention. Such problems are well-known in systems, such as the Internet web browser SSL model, that rely on a user authenticating a server, but in a way that never forces the user to do so. Active input of a password at one of the devices is generally more secure, because it is a step that cannot be ignored.

Password agreement protocols such as those used in the present invention will now be discussed. The goal of a password agreement protocol is to allow two devices to negotiate a connection key and a shared random password such that when the two devices have computed matching passwords, the connection is guaranteed to be secure against eavesdroppers, and secure against active attack in direct and sole proportion to the size of the password.

For example, a matching 4-digit password guarantees that there is a maximum 1/10,000 chance that a middleman is present. This guarantee is independent of the computational power of the middleman.

To show the subtlety of the password agreement protocol problem, a simple variant of a Diffie-Hellman key agreement will be discussed, which when used in the Out-Out password model, is open to attack.

When two devices interact for the first time, one of them initiates a Diffie-,Hellman key exchange, which results in both devices sharing a Diffie-Hellman agreed key. Both devices also derive a shared password from the agreed key. In an attempt to avoid the Diffie-Hellman middleman attack, both devices display the password in some suitable form, which the user cross-check's manually. If the passwords are the same, this is supposed to guarantee that no middleman has been involved. The system must also let the user abort when they do not match.

The security of Diffie-Hellman guarantees that a middleman cannot negotiate two identical keys with two target users. However, the security of a password agreement protocol requires a tighter constraint; that a middleman cannot negotiate two matching passwords with two target users. This constraint is also related in a subtle way to the general assumption that the user compares passwords accurately.

These assumptions are interrelated. Larger key values may seem to provide more security, but as larger values are also less convenient, they are more likely to encourage the user to make mistakes, or perhaps completely skip the confirmation step. The system may require the user to accurately compare cryptographically large passwords, but it may be vulnerable in light of the fact that people tend to ignore partial mismatches of large values, such as only looking at the first or last few digits. Thus, the present invention is concerned about attacks where the keys may appear similar enough to fool a significant number of users. Convenience is paramount issue that may force the system designer to compare small passwords, and at the very least requires the system to be reasonably secure when small portions of large passwords are compared.

The Maher paper further described steps to checking the received values to detect trivial cases of 1 and −1, and to split the transmitted values in half, sending first halves before both second halves, to prevent birthday attacks. While the Maher paper is unclear on the nature of the attack that is ostensibly prevented, an attack on that method is discussed below.

A generic class of middleman attack will be discussed relating to a simple Diffie-Hellman exchange that can exploit either (1) knowledge of human failure tendencies, or (2) knowledge of how a system truncates the display of the agreed keys. The general attack can be custom-tailored to fit a specific system or population of users. A more specific attack on the variation of this method mentioned in the Maher paper will also be discussed.

Constructive middleman attack on simple Diffie-Hellman will now be discussed.

Alice is a device that initiates a Diffie-Hellman exchange with another device (Bob). Mallory is an attacking middle-party that fully controls the communication channel between Alice and Bob. The security of Diffie-Hellman prevents Mallory from computing identical Diffie-Hellman agreed keys with both parties. However, Mallory's job is merely to construct an exponent to get both parties to derive (with her) two different agreed keys that generate passwords that are similar in appearance to each other, from the user's perspective. Here, Mallory will try to force a suitable key K_{A} on Alice to match (from the user's perspective) the key K_{B} that Mallory derives with Bob. This is called a constructive middleman attack.

Mallory is also a clever student of human behavior, and has discovered that people tend to ignore partial mismatches of long strings in the system. Mallory notices that most people only look at the first 4 decimal digits, so she insures that her Diffie-Hellman reply to the initiating party produces a result that matches, in the first 4 digits, the agreed key computed with the responder. The problem of comparing short passwords is generally the same as the problem of comparing short substrings of long passwords.

Or, more generally, Mallory has constructed a function F(K_{A}, K_{B}) that returns a probability (between 0 and 1) of a false match for any two Diffie-Hellman agreed keys K_{A} and K_{B}. F is customized to fit her target system and user population. In the case of the aforementioned lazy users who only look at 4 digits, or better still, in a system that only displays the first 4 digits of the agreed key, F(K_{A}, K_{B}) returns 1 when the first 4 digits of x are exactly equal to the first 4 digits of y, as displayed on the devices. Otherwise, F(K_{A}, K_{B}) returns 0. (Yes, in some systems you can fool all of the people, all of the time.) In the case of a system that displays a large sequence of digits, Mallory may assign a smaller non-zero probability depending on the appearance of different representations, for example it may turn out that F(K_{A}, K_{B})=0.13 when K_{A} displays as 1276549883 and K_{B} displays as 1279586883, indicating that about one eighth of the time people will mistakenly assume these numbers match. Mallory may also adjust the probabilities higher, if she suspects that some people will judge the numbers to be “close enough”.

Mallory might also use a probability value 0<P≦1 that represents the security threshold that she wants to achieve. She may keep guessing values until F(K_{A}, K_{B})24 P. In a system that displays too many digits to prevent Mallory from doing the perfect attack, she may alternately just keep guessing for a fixed period, and then simply choose from among the guesses that she thinks will produce the most likely match.

Mallory must also take into account the time delay she introduces, and may settle for a 1 in 100 chance of attack in some cases. Given that time it takes her to compute a good match may introduce a delay, she may settle for a not-so-good match rather than run the risk of delaying too long, if the random numbers don't “fall her way”.

In the attack, Alice sends g^{x} to Mallory, who, having nothing better to do, simply chooses a random x¹ and sends g^{x′} to Bob. When Bob responds with g^{y}, Mallory computes K_{B}=g^{yx′} and then chooses a series of random exponents {y′₁, y′₂, . . . } to use with Alice, and for each y′ₜ, computes g^{xy′}^{ₜ} and F(g^{xy′}^{ₜ}, g^{yx′}). As soon as F(g^{xy′}^{ₜ}, g^{yx′})≧P, Mallory proceeds with the attack by sending g^{y′}^{ₜ} to Alice. In the case where Mallory runs out of time, she may also decide to use the appropriate y′ₜ that yielded the largest probability of a match.

Table 1—Attack on 4-digit passive password—comparison of DH agreed key

| Alice | Mallory | Bob |
|---|---|---|
| g^{x}→ | g^{x′}→ | [symbol] g^{y} |
| | K_{B} = g^{yx′} | |
| | Choose random {y′₁, y′₂, . . . } | |
| | For each y′ᵢ in {y′₁, y′₂, . . . } | |
| | If F(g^{xy′}₁, g^{yx′}) ≧ P, | |
| | Let y′ = y′, and end search | |
| | [symbol] g^{y′} | |
| K_{A} = g^{xy′} | | K_{B} = g^{yx′} |
| π_{A} = K_{A} mod 1000 | | π_{B} = K_{B} mod 1000 |
| output π_{A} | | output π_{B} |

Table 1 shows an example of the attack in a system that derives a password π from just the low 4 digits of the Diffie-Hellman key, as in π=K mod 1000. In this case, Mallory sets P=1, and sets F(K_{A}, K_{B})=1 if ((K_{A} mod 1000)=(K_{B} mod 1000)), and otherwise sets F(K_{A}, K_{B})=0. Although K_{A} and K_{B} are distinct values when Mallory is successful, the π_{A} and π_{B} values will appear to be the same by the user, which permits Mallory to remain as a middleman in the protocol.

While it may seem unrealistic to expect Mallory to perform thousands of exponentiations, the conservative designer must presume a powerful adversary. It may be likely that Mallory has a moderately powerful CPU. Also, there is a significant opportunity for optimization, wherein Mallory can search for an appropriate exponent y′ using an incrementing series of exponents such that each guess requires a single multiply, rather than a full exponential calculation.

Table 2 gives some rough estimates for the computational cost of Mallory's attack, in different scenarios, when using devices with fixed-length password output. Mallory's work effort is measured in terms of a multiple of Bob's required computational work in one run of the protocol.

TABLE 2
Relative cost of attack for fixed-size password display

| Fixed | | | |
|---|---|---|---|
| password | Exponent size | Probability | Work effort |
| size (bits) | (bits) | of success | (Mallory/Bob) |
| 8 | 256 | 100% | 1 |
| 10 | 128 | 100% | 8 |
| 15 | 256 | 100% | 512 |
| 20 | 256 | 100% | 16536 |
| 20 | 256 | ≧25% | 4096 |
| 20 | 128 | ≧3% | 1024 |

In order to determine probability values for longer length password displays, one must also include factors that account for expected human error.

Given the already weakened status of the passive participation model, as compared to active participation, there is concern about attacks where the keys appear similar enough to fool a significant percentage of otherwise-attentive users.

The goal is to have a system that automatically precludes a constructive middleman attack. The present invention requires and uses protocols, typically variations of Diffie-Hellman, that are modified to preclude constructive middleman and other attacks.

The variation of Diffie-Hellman described in the Maher paper (shown in Table 3) uses a modulus p=2q+1, and includes added steps of checking for trivial values, and steps for splitting the Diffie-Hellman public keys in half and exchanging the first halves of the DH public keys before the second halves. The method is described as precluding any spoofer from being able to mount “a birthday attack to discover their secret parameters”. However, it is somewhat unclear what was intended here, and the method is in fact vulnerable to a spoofing birthday attack.

The “secret parameters” appear to be the Diffie-Hellman exponents x and y. Even without the defensive technique of transmitting first halves of the Diffie-Hellman keys first, it is not clear how a birthday attack by a spoofer would permit discovery of their secret parameters x and y. However, an active attack by a spoofer can negotiate an identical password (or “anti-spoof variable” in the Maher paper) between the two parties, even when using the splitting technique discussed in the Maher paper, as described herein.

In this description, 1 is the number of significant bits in the Diffie-Hellman modulus p. The function high(x)=x/2\hat{ }(½) computes the high-order bits that represent the first half of the value x, and the function low(x)=x % 2\hat{ }(½) computes the low-order bits that represent the second half of the value x.

TABLE 3
The Maher protocol

| Alice | Bob |
|---|---|
| high(g^{x}) → | |
| | [symbol] high(g^{y}) |
| low(g^{x}) → | |
| | [symbol] low(g^{y}) |
| check for g^{y} == 1, or −1 | check for g^{x} == 1, or −1 |
| K_{A} = g^{xy′} | K_{B} = g^{yx′} |
| π_{A} = K_{A} mod 1000 | π_{B} = K_{B} mod 1000 |
| output π_{A} | output π_{B} |

In the attack shown in Table 4, Mallory chooses x′ from a set of small values, perhaps beginning with 1. If I is 1024, and the base g is the value 2, as is commonly used in Diffie-Hellman, Mallory can create up to 512 distinct values for y′, as in {1, 2, 3, . . . 512}, that will result in the high-half of g^{y′} being the same value, in this case, with all zeroes set. The low half of g^{y′} will be a number that when combined with the high half, results in a value that is not one of the trivial values checked when using the Maher protocol, and may be used to successfully complete the Diffie-Hellman exchange.

TABLE 4
Attack on 4-digit passive Maher protocol

| Alice | Mallory | Bob |
|---|---|---|
| high(g^{x}) → | high(g^{x′}) → | |
| | [symbol] high(g ¹) | [symbol] high(g^{y}) |
| low(g^{x}) → | low(g^{x′}) → | |
| | | [symbol] low(g^{y}) |
| | K_{B} = g^{yx′} | |
| | Choose random {y′₁, y′₂, . . . } | |
| | For each y′ᵢ in {1, 2, . . ., 512} | |
| | If F(g^{xy′}^{ᵢ}, g^{yx′}) ≧ P, | |
| | Let y′ = y′ᵢ and | |
| | end search. | |
| | [symbol] low(g^{y′}) | |
| K_{A} = g^{xy′} | | K_{B} = g^{yx′} |
| π_{A} = K_{A} mod 1000 | | π_{B} = K_{B} mod 1000 |
| output π_{A} | | output π_{B} |

Mallory has a good chance of successfully finding a suitable y′ value in this attack, when the number of output possibilities for a is roughly comparable to the number of bits in the Diffie-Hellman modulus p.

With the above issues in mind, it is therefore an objective of the present invention to help users to establish a cryptographic connection between two devices in a secure and convenient manner. It is a further objective to provide improved password-based connection protocols, to accommodate a wide range of devices, including highly constrained applications where the devices have limited input and output capabilities. It is yet another objective of the present invention to prevent the user from being able to casually ignore steps that are required to make the connection secure.

### SUMMARY OF THE INVENTION

To accomplish the above and other objectives, the present invention provides for improved cryptographic systems and methods that allow secure connection of two devices over an open network, using passwords communicated or established in a process using at least one human participant. Passwords are used because cryptographically large keys are hard to process and because passwords may be communicated between people and devices using a wide variety of input and output mechanisms. Different requirements for these systems and methods relate to the use of one-time versus static passwords, active versus passive models of user participation, and different combinations of password-input and password-output mechanisms.

Some applications are best addressed using a zero-knowledge password proof, as provided by password-authenticated key agreement protocols. Other applications, such as the case of connecting two devices that have no means to physically input a password, are addressed using improved ephemeral password agreement protocols. The systems are specifically designed to help insure that the human participants do not skip essential steps that are required to make the methods secure, without imposing an unnecessary burden on the user.

The present invention thus uses either a password agreement protocol or a zero-knowledge password proof to establish a shared password and a shared key between two parties, and incorporates explicit steps to insure that the user(s) of the system authenticate that the same password is used at both devices.

In one embodiment using an Out-Out password device connection model, two devices perform a password agreement protocol to establish a shared password and a shared key. Each device displays the shared password to the user (a person using the device). The user is given an opportunity to check to see if the password matches that displayed on the other device, perhaps by communicating with other users, after which the user is given a chance to either accept or reject the password. If the password is rejected, the connection is aborted. This process can be repeated until the user accepts the password, at which time the devices establish a secure connection with the shared key.

Applications using the Out-Out password device connection model can use devices that have a simple single light-emitting diode (LED) display or a speaker for user output, for example. A synchronized blinking or beeping pattern corresponding to the password is output on each device. Detection of the synchronized pattern by the user gives the user the ability to either confirm or reject the secure connection between the devices, perhaps with the single push of a button to confirm, or by turning off the devices to reject.

In a preferred embodiment using an Out-In password device connection model, two devices use a password agreement protocol to establish a shared password and a shared key, or use a password authenticated key agreement protocol to derive a shared key from a password. In either case, the first device displays the shared password to its user (a person). This user conveys the password, perhaps in conjunction with one or more other people to the second system. After entry into the second system, the system verifies that the shared password is correct.

When using a password agreement protocol in the Out-In password device connection model, the protocol is first run, and then the second device simply compares the input password to the agreed value from the protocol. When they match, the agreed key output from the protocol is used to establish a secure channel.

When using a password authenticated key agreement protocol using the Out-In password device connection model, the password is first established at the first device, preferably chosen by the device and presented to the user, and then conveyed and input to the second device. At this point, the protocol is run, which tells the second device whether or not the input password at device two matches the password at the first device. When they match, the agreed key output from the protocol is used to establish a secure channel.

Applications using the Out-In password device connection model can use devices that have a simple LED display or a speaker for output and a push button switch for input. A synchronized blinking or beeping pattern corresponding to the password is output on the first device. The user inputs the password into the second device by depressing a push button on the second device in a pattern that imitates the pattern output on the first device.

### BRIEF DESCRIPTION OF THE DRAWINGS

The various features and advantages of the present invention may be more readily understood with reference to the following detailed description taken in conjunction with the accompanying drawing figures, wherein like reference numerals designate like structural elements, and in which:

FIG. 1 is a diagram illustrating exemplary systems in accordance with the principles of the present invention; and

FIG. 2 is a flow diagram illustrating an exemplary method in accordance with the principles of the present invention.

### DETAILED DESCRIPTION

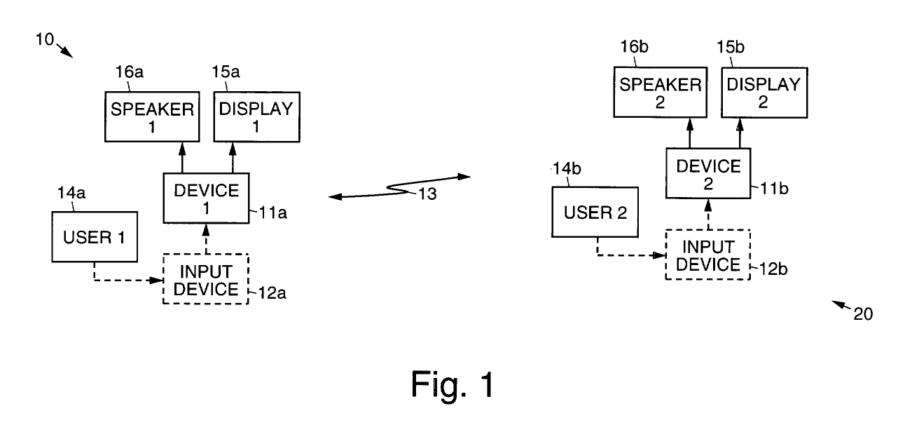

Referring to the drawing figures, FIG. 1 is a diagram illustrating exemplary cryptographic systems 10 in accordance with the principles of the present invention. The exemplary cryptographic systems 10 allow secure connection of two devices 11a, 11b over an open (unsecure) network 20 (generally designated).

An exemplary cryptographic system 10 comprises first and second device 11a, 11b. The first and second devices 11a, 11b each comprise an input device 12a, 12b. Each of the first and second devices 11a, 11b also comprise an output device, such as a display 15a, 15b, or a speaker 16a, 16b.

The exemplary cryptographic systems 10 comprise a communication protocol 13 that establishes a password and/or a shared key in between the first and second devices 11a, 11b. To accomplish this, the respective users 14a, 14b operate the first and second devices 11a, 11b or the respective input devices 12a, 12b, and evaluate outputs provided by the displays 15a, 15b, or speakers 16a, 16b to selectively allow secure connection of the first and second devices 11a, 11b.

Thus, the users 14a, 14b and/or the first and second devices 11a, 11b communicate and/or verify the password between the devices 11a, 11b. The evaluation of whether the passwords match determines whether the devices 14a, 14b permit secure connection of the devices 11a, 11b using the shared key.

In the present invention, three password device connection models may be employed in the present invention, including In-In, Out-In, and Out-Out models, where a user input/output devices 12a, 12b, 15a, 15b, 16a, 16b, or mechanisms, of each device 11a, 11b determines how a password can “flow” in the process. These three device connection models are discussed below.

In the In-In password device connection model, both devices 11a, 11b accept a password input value to establish the connection, and the connection is established only if the values match. The In-In model is representative of a typical network login, where the password input for a client device 11a comes from the user, and the password input for the authentication server device 11b comes from a password database at the authentication server device 11b. The In-In model is also useful in establishing a direct connection between two devices 11a, 11b that have keypads or other means for password entry.

In the Out-In password device connection model, the user 14a, 14b conveys a password from the output of one device 11a, 11b to the input of the other device 11b, 11a, and the connection is established only when the password is correct. In this case, the password may be an ephemeral secret chosen by the first device 11a. This may, in some cases, loosen the constraints on the scheme. In particular, when the secret is used only once, the protocol may reveal the value of the secret in failed runs, as long as each failed run is detected by the relevant user 14a, 14b.

The Out-Out password device connection model is relatively unusual. Both users 14a, 14b display a password to the other user 14a, 14b, and the users 14a, 14b may accept or reject the connection depending on whether or not the password values match. It may be useful for highly constrained environments, such as where no password input capability exists on either device 11a, 11b. In the Out-Out model each device 11a, 11b displays a connection identifier password to the user 14a, 14b, who is given the opportunity to approve or reject the connection depending on whether or not the values match.

Some protocol classes have special properties that make them well-suited for particular models. But in general, applications for these protocols are ubiquitous in network computing, and include new workstation to wireless intranet enrollment, new workstation to corporate VPN enrollment, cell phone to investment banking service transactions, PDA to movie theater ticket window transactions, PDA to banking ATM transactions, installation of dedicated wireless devices, with extremely limited display capability, login from a generic device with no prior stored keys or certificates, and everyday login with no stored local credentials.

It is presumed that any necessary identification of both users 14a, 14b is accomplished by an out-of-band, perhaps ad-hoc, mechanism that does not necessarily guarantee the security of the identification. Furthermore, whether or not the devices 11a, 11b have names may be irrelevant. The protocols employed in the present invention presume that the identification of the devices 11a, 11b has been accomplished.

An authenticating credential of password is chosen. In the case of infrared connections from a PDA/cell-phone to an ATM machine, for example, the identity of each device 11a, 11b is established by the user 14a, 14b, based on whatever powers of observation are available to the user. The PDA may be implicitly trusted. The machine may appear to be a sturdy expensive installation, with big logos, impressive locks, and other trappings of authority that one would not expect from a counterfeit device. In any case, that problem is out of scope for the purposes of the present invention.

The issue that is of concern is that, once the user 14a, 14b identifies the two devices 11a, 11b in question, how can a secure network connection be created between them such that no other rogue device can act as an unseen participant. Of course, none of this precludes having additional layers of protection that provide name-based and certificate-based authentication and authorization capabilities.

For the purposes of the present invention, each device 11a, 11b must have at least one password input channel (input device 12a, 12b) or at least one output channel (display 15a, 15b, speaker 16a, 16b) to the user. Depending on the configuration, each device 11a, 11b also generally has either a way to indicate to the user 14a, 14b that a connection is successful, or a way for the user 14a, 14b to abort the connection based on observations of output passwords.

In the Out-In active participation model, the user 14a, 14b conveys information from the output (display 15a, 15b, speaker 16a, 16b) of one device 11a, 11b to the input (input device 12a, 12b) of the other device 11a, 11b in the act of connecting. This model may use either ephemeral or static passwords.

The Out-Out model embodies the passive participation model, which is less intrusive on the user. In this model, the system 10 displays password data to the user 14a, 14b on each device 11a, 11b, giving the user 14a, 14b the chance to approve or disapprove of the connection depending on whether the displayed values match. Approval may come in the form of a simple yes/no keyed or clicked input, or, in the most extreme passive case, presenting the mere opportunity to turn off the device 11a, 11b to abort a potentially unsafe transaction.

Protocols for both active and passive models and their relative benefits are described herein. Protocols that require user action are generally stronger than those where both are passive, due to the risk that parties will neglect to take the proper action in the passive model.

Input/output mechanisms will now be discussed. Table 5 below shows the three different models, and their requirements for users 14a, 14b to input a password and/or accept an output password.

TABLE 5
Active participation models

| | |
|---|---|
| Alice | Bob |
| Password | Password |

| Model | in | out | in | out |
|---|---|---|---|---|
| In-only | yes | no | yes | no |
| Out and In | no | yes | yes | no |
| Out-only | no | yes | no | yes |

The recommended uses for password-authenticated key agreement protocols and password agreement protocols depends on different application constraints, which raises a number of questions. Is the password a persistent static value? Is the password limited to use for a short time interval? Is the password a one-time value that is never reused? Is mutual authentication needed, or is it acceptable to have authentication occur in only one direction? Is the password human-selected or machine-selected?

Computational constraints will now be discussed. In general, if the devices 11a, 11b have the ability to perform big number exponential calculations, of the kind suitable for public key operations, they can support all available methods. While for some very slow processors such operations can be time consuming, taking on the order of a second or two, the fact that it is limited to cases of human interaction generally makes it possible to use any available method in most cases The present invention provides for improved cryptographic systems 10 and methods 30 that allow secure connection of two devices 11a, 11b over an open network, using passwords communicated in an out-of-band process. One-time versus static passwords, active versus passive models of user participation, and different combinations of password-input and password-output mechanisms may be employed. The present invention uses either a password agreement protocol or a zero-knowledge password proof to establish a shared password and a shared key between two users 14a, 14b, and incorporates explicit steps to insure that the user(s) of the system authenticate that the same password is used at both devices 11a, 11b.

Some embodiments may use a zero-knowledge password proof, as provided by password-authenticated key agreement protocols. Other embodiments, such as the case of connecting two devices 11a, 11b that have no means to physically input a password, use improved ephemeral password agreement protocols. The systems 10 and methods 30 are specifically designed to help insure that human participants do not skip essential steps that are required to make the systems 10 and methods 30 secure, without imposing an unnecessary burden on the users 14a, 14b.

In one embodiment using an Out-Out password device connection model, two devices 11a, 11b perform a password agreement protocol to establish a shared password and a shared key. Each device 11a, 11b displays the shared password to a user 14a, 14b of the device 11a, 11b. The user 14a, 14b is given an opportunity to check to see if the password matches that displayed on the other device, perhaps by communicating with other users 14a, 14b, after which the user 14a, 14b is given a chance to either accept or reject the password. If the password is rejected, the connection is aborted. This process can be repeated until the user 14a, 14b accepts the password, at which time the devices 11a, 11b establish a secure connection with the shared key.

Applications using the Out-Out password device connection model can use devices 11a, 11b that have a simple single light-emitting diode (LED) display 15a, 15b or a speaker 16a, 16b for user output, for example. A synchronized blinking or beeping pattern corresponding to the password is output on each device. Detection of the synchronized pattern by the user gives the user 14a, 14b the ability to either confirm or reject the secure connection between the devices 11a, 11b, such as by pushing a button to confirm, or turning off the devices 11a, 11b to reject.

In the preferred embodiment using an Out-In password device connection model, two devices 11a, 11b use a password agreement protocol to establish a shared password and a shared key, or use a password authenticated key agreement protocol to derive a shared key from a password. In either case, the first device 11a displays the shared password to its user 14a. This user 14a conveys the password, perhaps in conjunction with one or more other people to the second device 11b. After entry into the second device 11b, it is verified that the shared password is correct.

When using a password agreement protocol in the Out-In password device connection model, the protocol is first run, and then the second device 11b simply compares the input password to the agreed value from the protocol. When they match, the agreed key output from the protocol is used to establish a secure channel.

When using a password authenticated key agreement protocol using the Out-In password device connection model, the password is first established at the first device 11a, preferably chosen by the device 11a and presented to the user 14a, and then conveyed and input to the second device 11b. At this point, the protocol is run, which tells the second device 11b whether or not the input password at the second device 11b matches the password at the first device 11a. When they match, the agreed key output from the protocol is used to establish a secure channel.

Applications using the Out-In password device connection model can use devices 11a, 11b that have a simple LED display 15a, 15b or a speaker 16a, 16b for output and a push button switch for input. A synchronized blinking or beeping pattern corresponding to the password is output on the first device 11a. The user 11b inputs the password into the second device 12b by depressing a push button, for example, or other selection mechanism, on the second device 11b in a pattern that imitates the pattern output on the first device 11a.

There is abundant literature that describes in detail password authenticated key agreement protocols. There is less prior art relating to password agreement protocols, and improved password agreement protocols are discussed here.

The first is PAP-1, an ephemeral password agreement protocol that is suitable for use in the passive model. It is based on a Diffie-Hellman exchange, with additional protective features to frustrate constructive middleman and other attacks. Specifically, the initiating party sends an additional commitment to a random value which is not revealed until the responding party has made its commitment. This random value is included in the computation of the agreed key, and thus prevents the middleman from contriving to make the two keys appear similar.

The PAP-1 protocol is summarized in Table 6, and begins with Alice sending Bob her DH public key g^{x}. Along with this, she sends Bob a commitment to a random value c_{A}=h(0, r_{A}). In this case, h is the standard SHA1 hash function discussed in “Secure Hash Standard”, FIPS 180-1, U.S. National Institute of Standards and Technology that operates on a number of concatenated input field values (presuming that each field is padded to an appropriate fixed size or formatted to indicate the size of the field) and computes a 160-bit hash result. Bob must receive Alice's commitment c_{A} before he sends her his Diffie-Hellman public key g^{y}. Both Alice and Bob then compute the Diffie-Hellman agreed key z=g^{xy}.

Only after the Diffie-Hellman public key exchange is complete does Alice reveals her random value r_{A} to Bob, who then makes sure that it corresponds with her commitment c_{A}. If the commitment doesn't match, Bob must abort the protocol. Otherwise each party derives a display password value, π_{A} and π_{B} respectively, from a hash function of both the agreed key z and Alice's committed random value r_{A}. They also each derive a connection encryption key from another distinct hash function of z.

TABLE 6
PAP-1 protocol

| Alice | | Bob |
|---|---|---|
| choose xε_{R} [1, q] | | choose yε_{R} [1, q] |
| choose r_{A}ε_{R} [0, 2¹⁶⁰ − 1] | | |
| c_{A} = h(0, r_{A}) | c_{A}, g^{x} → | abort if g^{x} is invalid |
| abort if g^{y} is invalid | [symbol] g^{y} | |
| z = g^{yx} | | z = g^{xy} |
| | r_{A} → | abort if c_{A} ≠ h(0, r_{A}) |
| π_{A} = Display(h(3, r_{A}, z)) | | π_{B} = Display(h(3, r_{A}, z)) |
| output π_{A} | | output π_{B} |
| connection key | | connection key |
| K_{A} = h(4, r_{A}, z) | | K_{B} = h(4, r_{A}, z) |

This protocol effectively reduces the middleman attack success probability to the minimum value that corresponds to the size of the password being compared. It achieves this by forcing Mallory to commit herself to all relevant values before Alice and Bob reveal enough for Mallory to create a customized result for either party.

The PAP-1 protocol permits a user 14a, 14b to compare a small number of bits, to get an appropriate and scalable level of security and comfort. To display a roughly 10-bit (3 digit) password, one might choose Display(x)=h(x) mod 1000, which gives the user 14a, 14b gets a thousand-to-one guarantee that no middleman is present. With 6 digits, the user 14a, 14b gets a million to one guarantee.

The domain parameters for the Diffie-Hellman exchange can be chosen in accordance with best practices for Diffie-Hellman key exchange, such as those described for the EC/DLKAS-DH1 method described in IEEE Std 1363-2000, IEEE Standard Specifications for Public-Key Cryptography, 29 Aug. 2000. Both Bob and Alice should validate the other's received DH public key, and abort if invalid, and in general take precautions to prevent small subgroup confinement as discussed in the IEEE Std 1363-2000, IEEE Standard Specifications for Public-Key Cryptography, 29 Aug. 2000, and the D. Jablon, “Strong password-only authenticated key exchange” paper, and in the discussion of PAP-2 below. IEEE Std 1363-2000, IEEE Standard Specifications for Public-Key Cryptography, 29 Aug. 2000 describes DH for both original multiplicative integer groups and elliptic curve groups, both of which may be used in these methods.

The commitments and revelations must be ordered correctly to prevent attack. Specifically, in the PAP-1 protocol, it is necessary for Bob to receive CA before he sends g^{y}, and it is necessary for Alice to receive g^{y} before she sends r_{A}.

Table 7 shows a PAP-2 protocol, a variation of the PAP-1 protocol that separates a prior standard Diffie-Hellman key exchange from an added commitment exchange. In this variation, the Diffie-Hellman key exchange may be replaced with any comparable scheme that results in a shared key z.

TABLE 7
PAP-2 protocol

| Alice | | Bob |
|---|---|---|
| choose xε_{R} [1, q] | | choose yε_{R} [1, q] |
| | g^{x} → | abort if g^{x} is invalid |
| abort if g^{y} is invalid | [symbol] g^{y} | |
| z = g^{yx} | | z = g^{xy} |
| choose r_{A}□_{R} [0, 2^{160 -1]} | | choose r_{B}□_{R} [0, 2^{160 -1]} |
| c_{A} = h(0, r_{A}) | c_{A} → | |
| | [symbol] r_{B} | |
| | r_{A} → | abort if c_{A} ≠ h(0, r_{A}) |
| π_{A} = Display(h(3, r_{A}, r_{B}, z)) | | π_{B} = Display(h(3, r_{A}, r_{B}, z)) |
| output π_{A} | | output π_{B} |
| connection key | | connection key |
| K_{A} = h(4, r_{A}, r_{B}, z) | | K_{B} = h(4, r_{A}, r_{B}, z) |

When using a pre-existing implementation of Diffie-Hellman, where one may not be sure if it has properly validated the public keys g^{x} and g^{y}, it may be sufficient to validate the agreed key z. One such technique is to insure that z is an element of the proper group, and an element of suitably large order. One must abort if z is out of range (i.e. not an element of the group) or if z is of too small an order. For example, when using Zₚ*, the multiplicative group of integers modulo p, where p=kq+1, and p and q are prime, the range can be validated by insuring that 1≦z<p. The order of z can be insured to be suitably large by aborting if z^{k}=1, or aborting if z^{q}≠1 (when gcd(k,q)=1), or, when the factors of k are known, computing the product s of the unsuitably small factors of k and aborting if z^{s}=1.

An alternative construction can use the Rivest and Shamir Interlock protocol. The PAP-RS protocol (shown in Table 8) is constructed by choosing the password as a small hash of the two random messages r_{A} and r_{B} that are exchanged using the Interlock protocol. It is further essential that Alice and Bob coordinate to ensure that each has received the other's commitment before the reveal phase begins.

TABLE 8
PAP-RS protocol

| Alice | | Bob |
|---|---|---|
| choose random r_{A} | | choose random r_{B} |
| | Public_{A} → | |
| | [symbol] Public_{B} | |
| M_{A} = encrypt( Public_{B}, r_{A}) | hash(1, M_{A}) → | |
| | [symbol] hash(2, M_{B}) | M_{B} = encrypt( Public_{A}, r_{B}) |
| | M_{A} → | |
| | [symbol] M_{B} | |
| r_{B} = decrypt( Private_{A}, M_{B}) | | r_{A} = decrypt( Private_{B}, M_{A}) |
| π_{A} = Display(hash(3, r_{A}, r_{B})) | | π_{B} = Display(hash(3, r_{A}, r_{B})) |
| output π_{A} | | output π_{B} |
| connection key | | connection key |
| K_{A} = hash(4, r_{A}, r_{B}) | | K_{B} = hash(4, r_{A}, r_{B}) |

One application for these methods that use password agreement protocols is a secure handshake between two people in a crowded room. Imagine two people at a conference, airport, or other public setting, who wish to share some sensitive electronic information. In the crowded room scenario, it may be unreasonable to expect that there is a confidential channel for establishing a shared secret password. In this case, a password agreement protocol that does not require secrecy for the transmitted password may be more suitable than a protocol that requires secrecy for the transmitted password.

In the passive model, authentication is implicit. The user 14a, 14b is responsible for explicitly authenticating the connection for both parties. Specifically, when the passwords do not match, the users 14a, 14b may need to abort the connection on one of the devices 11a 11b, or on both devices 11a 11b to provide mutual authentication, depending on the application. In this regard, some form of active participation is required, when possible, and is a superior approach to preventing failure, as neglectful behavior appears to be the norm in almost all systems.

A password agreement protocol achieves a somewhat weaker objective than that provided by a password-authenticated key agreement protocol which provides a mutual zero-knowledge password proof. In a password agreement protocol, an active attacker gets the actual negotiated password with each party that it interacts with.

In this regard, a password agreement protocol is analogous to an anonymous key agreement protocol, such as Diffie-Hellman. The revelation of the ephemeral negotiated password to any party is analogous to the revelation of the negotiated ephemeral shared key in a middleman attack on unauthenticated Diffie-Hellman. The active attacker always obtains the “real” agreed key/agreed password with each victim. The essential feature of the password agreement protocol is that a middleman cannot obtain the same password for two other parties, without an interactive exhaustive attack against at least one of the parties, which requires a average number of runs proportional to the number of possible passwords.

Variations of the present invention will now be discussed. The first variation is the use of password agreement protocols in the active model.

Password agreement protocols are also useful in the ephemeral, Out-In model, especially when only unilateral authentication is required. A negotiated password displayed by the Out device is conveyed by the user to an In device 11a, which compares the user input value to the negotiated value. When the values match, an Out device 11b accepts the connection, otherwise the connection is aborted.

A protocol that requires user action is stronger than one where both are passive, due to the risk that parties may neglect to take the proper action in the passive model. A password agreement protocols used in the active model is where, after establishing a Diffie-Hellman key, one party sends an out of band derived password derived from the key to the other, which is verified by the other against his copy of the agreed key.

TABLE 9
Use of password agreement protocol in an active model

| Alice | | Bob |
|---|---|---|
| . . . obtain π_{A} from a | | . . . obtain π_{B} from a |
| password agreement | | password agreement |
| protocol . . . | | protocol . . . |
| output π_{A} | π_{A} → (out of band) | input π_{A} |
| | | abort if π_{A} ≠ π_{B} |

Table 9 shows how to convert any password agreement protocol to active form. However, this form of active authentication is unilateral, in this case, from Alice to Bob. Alice is never assured that Bob in fact has the actual password, unless the user takes additional action. For example, when Bob informs the user that the password doesn't match, the user may turn off Alice.

To assist the users 14a, 14b, the devices 11a, 11b may display instructions to guide the user's actions, as follows:

Alice's device 11a tells Alice:

“Ask Bob “What's the word?”, get the word from Bob, and enter it here: ______”

“Tell Bob the word is correct.”

Bob's device 11b tells Bob:

“Tell Alice the word is “foo” when she asks for it, and ask her to verify it.”

Who goes first?

It may be important to use variations of these methods to handle the case where no designated party is the initiator. A simplistic approach is to have each party send a commitment value to the other, as in the PGPfone system. However, that approach required more messages to be sent than necessary.

When there is no designated initiating party, the parties can use identical roles. Each party must insure that it has received a commitment of the other party's value before revealing it's own value. Furthermore, both parties can sort the exchanged values in an agreed manner before hashing them to derived the shared key or password.

Variations in input/output devices will now be discussed.

Password-based active connection protocols provide a wide range of flexibility. They may be used with almost any kind of input device 12a, 12b, beyond mere keyboards and key pads, including microphones (with or without speech recognition), mice and other pointing devices, and even simple push-button or toggle switches. They may also be used with many kinds of output devices 15a, 15b, 16a, 16b, including LEDs, monotonic tone generators, speakers, small text and graphic displays, etc. For example, techniques for out-of-band password transmission can include a user 14a, 14b pressing a button or key on one device 11a in synchronization with a flashing LED, graphic display, or perhaps an intermittent tone output from the other device 11b, a user 14a, 14b clicking a number of times corresponding to each digit with a pause between digits (similar to imitating a rotary dial telephone), or a user 14a, 14b holding a handheld device up to a terminal screen to confirm that two graphical or numeric displays are indeed synchronized, as in: “Does your device show Connection Password 18564? YES or NO38 .

In the passive model, it may be wise in some applications to randomly change the nature or location of the YES/NO prompt to prevent undesirable automatic YES responses from the user 14a, 14b. In other applications, one might simply display the connection password on each device 11a, 11b during the entire connection, and offer the user 14a, 14b the chance to abort at any time.

However, some care is needed in the design of the user interface, especially in passive systems 10. Consider the case of two devices 11a, 11b that have just a power-switch for input, and a single blinkable LED for output. One might use a password agreement protocol to make these two devices display a flashing pattern on the LED display immediately after power-up, to give the user the chance to see whether the two devices 11a, 11b are flashing the same pattern in synchronization. If the two devices 11a, 11b are likely to be used in situations where they cannot be seen at the same time, the pattern should be something memorable, or recordable.

It should also remain displayed long enough for the user to get to the other device, or to allow a trusted associate to relay the output of the other device to the user 14a, 14b for comparison. One might want choose to have the connection password remain displayed for the duration of the device association, to allow connection integrity to be verified at any future time. However, this may be undesirable in an environment where a middleman has access to the reset/power switch of one of the target devices 11a, 11b, and can repeatedly re-initialize the connection until the passwords coincide.

It is also important that the devices 11a, 11b be designed so that they cannot be automatically reset due to unauthenticated requests from the network. In general one must carefully consider both physical and electronic (network) threats.

All display and input techniques must also take into account any risks of out-of-band password disclosure, which highly depends on the deployment environment. For example, it may be undesirable to shout out even one-time passwords in a crowded room.

It is generally preferable for passwords to be chosen by a device 11a, 11b using a good random process. When the user 14a, 14b chooses his own password value to be entered into both devices 11a, 11b, it too can be incorporated into the exchange and used to derive the value of g (as in SPEKE), or incorporated into the value of z.

However, with user-chosen passwords, there is always the chance that a user 14a, 14b will re-use the same password in subsequent exchanges. Thus, in settings where the user 14a, 14b may choose the password, it is preferable to use a zero-knowledge password proof, to prevent any leakage of the password to an electronic adversary.

In summary, human limitations require that passwords be used in device connection protocols, which must in turn be carefully designed to safely handle these low-entropy authenticators. Password-based connection protocols have been discussed that may be used to help people to securely connect two devices over an open network, using a wide variety of password input and output devices 12a, 12b, 15a, 15b, 16a, 16b. Password-authenticated key agreement protocols are ideal in many cases, but in highly constrained environments, password agreement protocols are needed.

Ephemeral password agreement protocols may be used, and use scenarios for the special case of connecting two devices 11a, 11b that have no means to physically input a password have been disclosed. These are shown to be able to securely connect a pair of wireless devices 11a, 11b that have only a single LED user output, with the only user input mechanism being a power-on or reset switch.

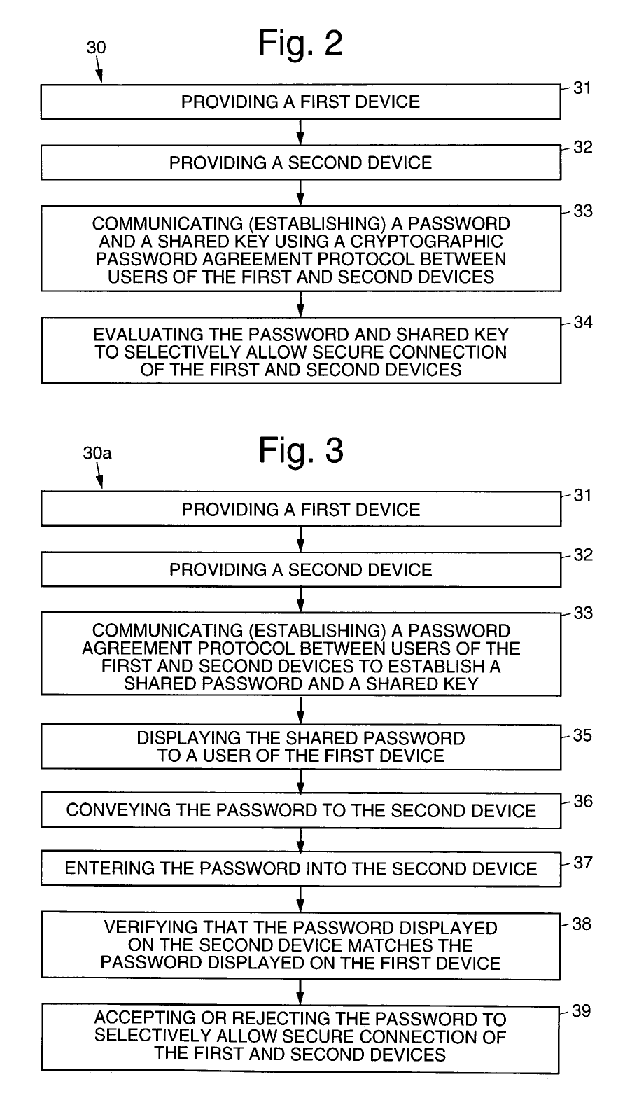

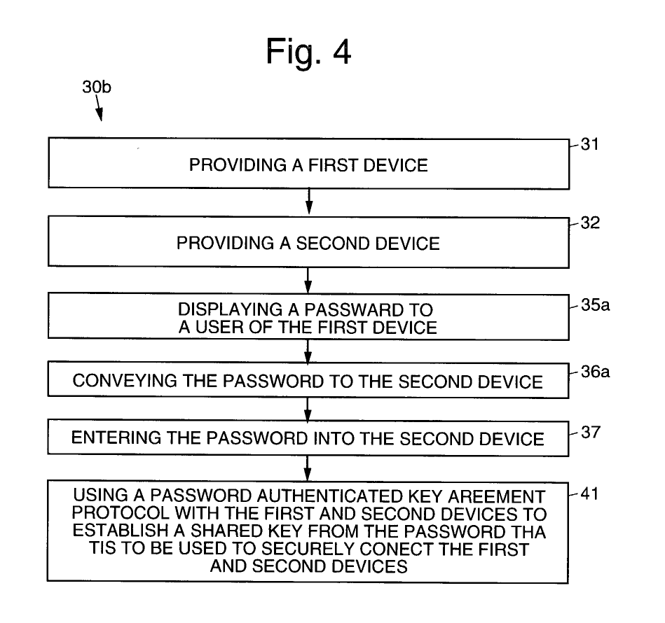

For the purposes of completeness, FIG. 2 is a flow diagram illustrating a first exemplary method 30 in accordance with the principles of the present invention. The exemplary method 30 allows secure connection of two devices over an open network. The exemplary method 30 comprises the following steps.

A first device is provided 31. A second device is provided 32. A password and a shared key are established 33 using a cryptographic password agreement protocol 33 between the first and second devices 31, 32. The passwords are evaluated 34 by the user or users 14 of the devices who act to selectively allow secure connection of the first and second devices 31, 32. This exemplary method embodies an Out-Out password device connection protocol that comprises using a password agreement protocol with the first and second devices to establish a shared password and a shared key, displaying the shared password to the respective user(s) 14 of the devices, checking to see if the password displayed on one device matches the password displayed on the other device, and accepting or rejecting the password to selectively allow secure connection of the two devices. Displaying the shared password may involve displaying a synchronized blinking pattern corresponding to the password on the first and second devices using a light-emitting diode (LED) display as an output device of one or more of the first and second devices. Displaying the shared password may also involve outputting a synchronized beeping pattern corresponding to the password using a speaker as an output device of one or more of the first and second devices.

Referring to FIG. 3, another exemplary method 30 a uses an Out-In password device connection protocol. In the second exemplary method 30a, a first device is provided 31 and a second device is provided 32. The method 30a comprises establishing 33 using a password agreement protocol a shared password and a shared key between the first and second devices 11a, 11b, displaying 35 the shared password to a user 14a, 14b of the first device 11a, the user(s) conveying 36 the password to the second device 11b, entering 37 the password into the second device 11b, verifying 38 that the password displayed on the second device 11b matches the password displayed on the first device 11a, and accepting or rejecting 39 the password to selectively allow secure connection of the two devices 11a, 11b.

Referring to FIG. 4, a third exemplary method 30b uses an Out-In password device connection protocol. In the third exemplary method 30b, a first device is provided 31 and a second device is provided 32. The third exemplary method 30b comprises displaying 35a a password to a user 14a, 14b of the first device 11a, conveying 36a (or communicating 35a) the password to the second device 11b, entering 37 the password into the second device 11b, using a password authenticated key agreement protocol with the first and second devices 11a, 11b to establish 41 a shared key from the password that is to be used to securely connect the two devices 11a, 11b.

Thus, systems and methods that provide for password-based connection of two devices have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A cryptographic system that allows secure connection of two devices over an open network, comprising:
a first device;
a second device; and
a password and a shared key that are established in a cryptographic protocol between the first and second devices, which password is communicated in an out-of-band process by one or more users of the devices to selectively allow secure connection of the two devices.

2. The cryptographic system recited in claim 1 wherein the password is established using a password agreement protocol.

3. The cryptographic system recited in claim 1 wherein knowledge of the password is communicated using a zero-knowledge password proof.

4. The cryptographic system recited in claim 3 wherein the zero-knowledge password proof comprises a password-authenticated key agreement protocol.

5. The cryptographic system recited in claim 1 wherein the password is established using an ephemeral password agreement protocol.

6. The cryptographic system recited in claim 1 wherein an Out-Out password device connection protocol is employed wherein the first and second devices use a password agreement protocol to establish a shared password and a shared key, each device displays the shared password to its respective user, each user is given an opportunity to check to see if the password matches the password displayed on the other device, after which each user accepts or rejects the password to selectively allow secure connection of the two devices.

7. The cryptographic system recited in claim 6 wherein the first and second devices comprises a light-emitting diode (LED) display and a synchronized blinking pattern corresponding to the password is output on each device.

8. The cryptographic system recited in claim 6 wherein the first and second devices comprises a speaker and a synchronized beeping pattern corresponding to the password is output on each device.

9. The cryptographic system recited in claim 1 wherein an Out-In password device connection protocol is employed wherein the first and second devices use a password agreement protocol to establish a shared password and a shared key, the first device displays the shared password to its user who conveys the password to the second device, the password is entered into the second device, and the shared password is verified by the second device to allow secure connection of the two devices.

10. The cryptographic system recited in claim 1 wherein an Out-In password device connection protocol is employed wherein the first and second devices use a password authenticated key agreement protocol to derive a shared key from a password, the first device displays the shared password to its user who conveys the password to the second device, the password is entered into the second device, and the shared password is verified to allow secure connection of the two devices.

11. A cryptographic method that allows secure connection of two devices over an open network, comprising the steps of:
providing a first device;
providing a second device;
establishing a password in an out-of-band process between users of the first and second devices; and
evaluating the password by the respective users to selectively allow secure connection of the two devices.

12. The cryptographic method recited in claim 11 wherein the password is established between the first device and the second device using a password agreement protocol.

13. The cryptographic method recited in claim 11 wherein the password is evaluated and verified using a zero-knowledge password proof.

14. The cryptographic method recited in claim 13 wherein the zero-knowledge password proof comprises a password-authenticated key agreement protocol.

15. The cryptographic method recited in claim 11 wherein the password is established using an ephemeral password agreement protocol.

16. The cryptographic method recited in claim 11 wherein an Out-Out password device connection protocol is employed which comprises the steps of:
using a password agreement protocol with the first and second devices to establish a shared password and a shared key;
displaying the shared password to a respective user of each device;
checking to see if the password displayed on one device matches the password displayed on the other device; and
accepting or rejecting the password to selectively allow secure connection of the two devices.

17. The cryptographic method recited in claim 16 wherein the step of displaying the shared password comprises the step of displaying a synchronized blinking pattern corresponding to the password on the first and second devices using a light-emitting diode (LED) display.

18. The cryptographic method recited in claim 16 wherein the step of displaying the shared password comprises the step of outputting a synchronized sound corresponding to the password.

19. The cryptographic method recited in claim 11 wherein an Out-In password device connection protocol is employed which comprises the steps of:
using a password agreement protocol with the first and second devices to establish a shared password and a shared key;
displaying the shared password to a user of the first device;
conveying the password to the second device;
entering the password into the second device;
verifying that the password displayed on the second device matches the password displayed on the first device; and
accepting or rejecting the password to selectively allow secure connection of the two devices.
